(19) United States
(12) Patent Application Publication
(10) Pub. No.: US 2025/0389039 A1
(43) Pub. Date: Dec. 25, 2025

(54) SYSTEM AND METHODS OF WATER ELECTROLYSIS

(71) Applicant: Schlumberger Technology Corporation, Sugar Land, TX (US)

(72) Inventors: Wenlin Zhang, Menlo Park, CA (US); Florence Binet, Houston, TX (US); Eric Lavrut, Clamart (FR); Rafael Fejervary, London (GB); Alan Nelson, Houston, TX (US)

(21) Appl. No.: 19/248,508

(22) Filed: Jun. 25, 2025

Related U.S. Application Data
(60) Provisional application No. 63/663,723, filed on Jun. 25, 2024.

(51) Int. Cl. C25B 15/08; B03C 1/023; B03C 1/033; C25B 1/04; C25B 9/21; C25B 9/60; C25B 11/036

(52) U.S. Cl. CPC C25B 15/08; B03C 1/023; B03C 1/0335; C25B 1/04; C25B 9/21; C25B 9/60; C25B 11/036

(57) ABSTRACT

The present disclosure generally provides water electrolysis systems and methods. The systems include a first electrode set with a first bipolar plate electrically coupled to a power source. A first electrode is disposed adjacent to the first bipolar plate and in electrical contact with the first bipolar plate. The first electrode is disposed adjacent to a first side of a diaphragm. The systems include a second electrode set with a second bipolar plate and a second electrode. The second electrode is disposed adjacent to a second side of the diaphragm that is opposite the first side. A first electromagnetic conductive loop is embedded within the first electrode set. The first electromagnetic conductive loop is oriented horizontally along a vertical stand electrode plane. The Lorentz force associated with the generated electromagnetic field and the electric field of water electrolysis facilitates gas bubble expulsion from the electrolyzer system, thereby improving electrolysis efficiency.

### CROSS-REFERENCE TO RELATED APPLICATIONS

This application claims priority to and the benefit of U.S. Provisional Patent Application No. 63/663,723, filed Jun. 25, 2024 which is incorporated herein by reference in its entirety.

### BACKGROUND

Electrolysis of water is utilized for the production of hydrogen (H₂) to be used as an alternative energy source and green hydrogen for hard-to-abate heavy industries such as chemical and steel industries. Electrolysis of water requires water as a feed material and converts, using an electrochemical cell, water into H₂ and diatomic oxygen (O₂) via a redox reaction by applying an external electrical power to the cell. Electrolysis of water is generally implemented by an electrolyzer system that includes one or more stacks of electrochemical cells. Electrolyzer cells make use of an electrochemical reaction in a cell that comprises an anode, cathode, catalyst, gas distribution field and electrolyte.

Conventional electrolyzer, such as liquid alkaline electrolyzers, suffer from gas bubbles forming on the electrodes and/or diaphragm, causing impedance for mass transfer of ionic species, and potentially blocking electrode reaction locations resulting in higher polarization. This can lead to reduced ionic conductivity and a higher percentage of gas bubbles in the liquid electrolyte, thereby increasing the likelihood for mixing oxygen and hydrogen gas formed by the electrolysis reaction and increasing safety and purity concerns.

Accordingly, improved methods of water electrolysis are needed.

### SUMMARY

The present disclosure generally provides systems and methods of water electrolysis. The systems include a first electrode set. The first electrode set includes a first bipolar plate electrically coupled to a power source. A first electrode is disposed adjacent to the first bipolar plate and in electrical contact with the first bipolar plate. The systems include a diaphragm. The first electrode is disposed adjacent to a first side of the diaphragm. The systems include a second electrode set. The second electrode set includes a second bipolar plate and a second electrode. The second electrode is disposed adjacent to a second side of the diaphragm. The second side is opposite the first side. At least a first electromagnetic conductive loop is embedded within the first electrode set. The first electromagnetic conductive loop is oriented horizontally along a vertical stand electrode plane.

The present disclosure also generally provides systems and methods of water electrolysis. The methods include generating a current between a first electrode set and a second electrode set separated by a diaphragm, and circulating water within one of the first electrode set or the second electrode set. The first electrode set includes a first bipolar plate electrically coupled to a power source, and a first electrode disposed adjacent to the first bipolar plate and to a first side of the diaphragm and in electrical contact with the first bipolar plate. The second electrode set includes a second bipolar plate and a second electrode. The second electrode is disposed adjacent to a second side of the diaphragm. The second side is opposite the first side, and in electrical contact with the second bipolar plate. The current, in the presence of water, produces an electrolysis reaction. A Lorentz force oriented substantially towards a first channel is generated in the first electrode set using a first electromagnetic conductive loop. A first product of the electrolysis reaction is directed to a first channel fluidly coupled to the first electrode set using a diaphragm and the first Lorentz force.

The following description and the appended figures set forth certain features for purposes of illustration.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIG. 1 is a schematic view of an electrolyzer cell, according to embodiments of the present disclosure.

FIGS. 2A and 2B are schematic views of a bipolar plate, according to embodiments of the present disclosure.

FIGS. 3A and 3B are schematic views of an electrolyzer cell having an embedded electromagnetic conductive loop in the electrode, according to embodiments of the present disclosure.

FIG. 4 is a schematic view of an electrolyzer cell having an embedded electromagnetic conductive loop in the bipolar plate, according to embodiments of the present disclosure.

FIG. 5 is a flow diagram of a method for electrolyzing water, according to embodiments of the present disclosure.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates to systems and methods of water electrolysis. The present disclosure includes a coating material disposed on a bipolar plate, e.g., a concave or planar portion of the bipolar plate, to prevent bubble adhesion to the bipolar plate walls. The coating material facilitates movement of the bubbles, e.g., gas bubbles of hydrogen and/or oxygen, towards the manifold to help improve overall energy efficiency and reduce over-potential. Additionally, the present disclosure includes an electromagnetic conductive loop embedded within the electrode and/or bipolar plate to generate a Lorentz force parallel to the bipolar plate, thereby directing gas bubbles to a first channel and/or second channel of a manifold. The electromagnetic conductive loops can be mounted directly to the bipolar plate and/or the electrode, thereby providing a Lorentz force to direct bubbles e.g., gas bubbles of hydrogen and/or oxygen, towards the manifold to help improve overall energy efficiency and reduce over-potential. The present disclosure can provide a large-scale water electrolysis process capable of creating a Lorentz force using an electromagnetic field and an electric field, thereby avoiding large-scale magnets that may pose health hazards and/or be costly.

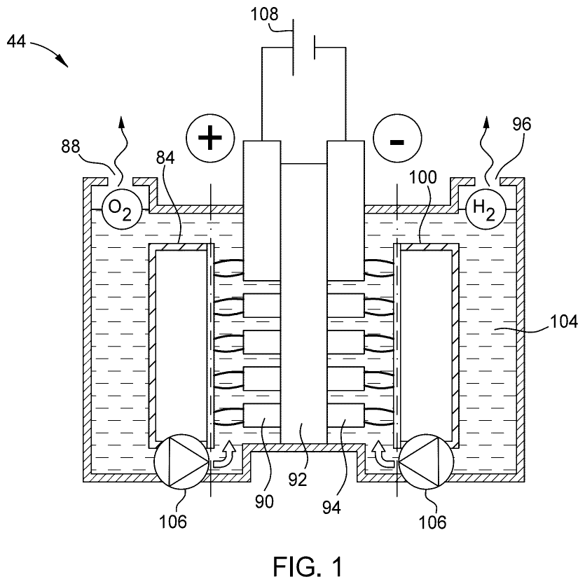

FIG. 1 shows a detailed view of the electrolyzer cell 44. In this view only one electrolyzer cell is shown, however, two or more electrolyzer cells may be coupled in series in order to increase hydrogen production. The electrolyzer cell 44 includes a first bipolar plate 84 that is adjacent to a first channel 88 and a first electrode 90. The first channel 88 may be a channel suitable to recover one or more reaction products of an electrolysis reaction, e.g., H₂ and/or O₂. For example, the first channel 88 may be suitable to recover a reaction product of O₂. A positive charge may be supplied to the first bipolar plate 84 via a power source 108. The first bipolar plate 84 is electrically coupled to the first electrode 90. The first electrode 90 can include a conductive material, e.g., a nickel mesh. The first electrode 90 is a mesh material, thereby allowing for electrolysis reaction products, e.g., gaseous bubbles such as O₂, to form.

Adjacent to the first electrode 90 is a diaphragm 92. The diaphragm 92 can be non-conductive to electrons. The diaphragm 92 can include a composite material, e.g., Zirconia and polysulfone. Without being bound by theory, the diaphragm 92 can allow OH-ions to pass through the diaphragm 92, while restricting gases from passing through.

Adjacent to the diaphragm 92 is a second electrode 94 and a second channel 96. The second channel 96 may be a channel suitable to recover one or more reaction products of an electrolysis reaction, e.g., H₂ and/or O₂. For example, the second channel 96 may be suitable to recover a reaction product of H₂. The second electrode 94 can include a conductive material, e.g., a nickel mesh. The second electrode 94 is a mesh material, thereby allowing for electrolysis reaction products, e.g., gaseous bubbles such as H₂, to form. Adjacent to the second electrode 94 is a second bipolar plate 100. A negative charge may be supplied to the second bipolar plate 100 via the power source 108. The second bipolar plate 100 is electrically coupled to the second electrode 94.

The electrolyzer cell 44 is immersed in an ionic solution 104. The ionic solution 104 includes an alkaline solution, e.g., a solution having a pH greater than 7, e.g., greater than 7.5, greater than 8, greater than 9, greater than 10, or greater than 11. The alkaline solution can include an aqueous solution having an electrolyte, e.g., a hydroxide electrolyte. For example, the ionic solution can include a mixture of water and potassium hydroxide. The electrolyzer cell 44 receives electrolyte solution 104 from a pump 106. The pump 106 can include any pump suitable to circulate an aqueous fluid, e.g., electrolyte solution 104.

In operation, the electrolyzer cell 44 may receive a positive charge at the first bipolar plate 84 and a negative charge at the second bipolar plate 100, thereby creating a voltage difference across the first electrode 90 and the second electrode 94, which is separated by the diaphragm 92. Due to the voltage difference and the supply of electrolyte from the pump 106, water may be reduced at the second electrode 94 to form H₂ and OH⁻. The H₂ may then diffuse and be directed out of the second channel 96, e.g., via convectional flow. The OH⁻ may transfer through the diaphragm and be oxidized on the first electrode 90, to produce H₂O and O₂ gas. The O₂ may diffuse out and be directed out the first channel 88, e.g., via convectional flow, in which the H₂O may recirculate throughout the electrolyzer cell 44 to be further reacted.

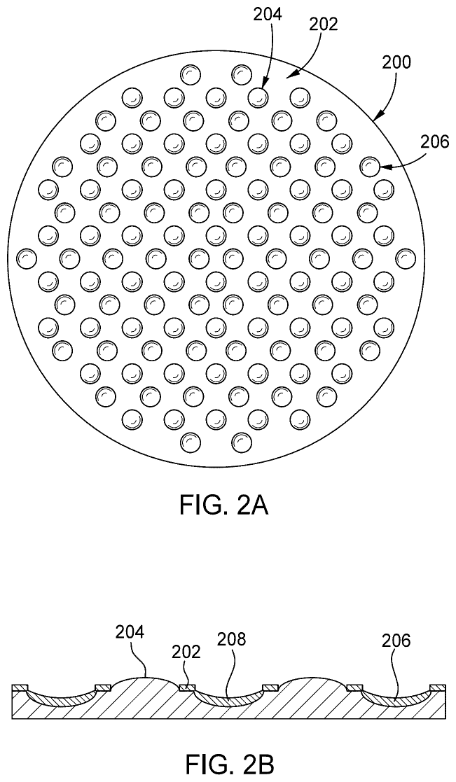

FIG. 2A shows a detailed view of a bipolar plate 200. The bipolar plate 200 can include any of the first bipolar plate 84 and/or the second bipolar plate 100, as described herein. The bipolar plate 200 can include a planar portion 202. The planar portion 202 includes a portion that is substantially planar and/or flat. A convex portion 204 extends from the planar portion 202. The convex portion 204 can extend from the planar portion 202 in a substantially circular, spherical, or cylindrical manner. The convex portion 204 can extend from the planar portion 202 such that the convex portion 204 contacts the electrode, e.g., the first electrode 90 and/or the second electrode 94, as described herein. While FIG. 2A shows one arrangement of convex portions on the bipolar plate 200, any number of arrangements of convex portions may be implemented on the bipolar plate 200.

A concave portion 206 is recessed within the planar portion 202. The concave portion 206 can recess from the planar portion 202 in a substantially circular, spherical, or cylindrical manner. The concave portion 206 can recess from the planar portion 202 such that the gas bubbles and/or fluid may interact with the concave portion 206. While FIG. 2A shows one arrangement of convex portions on the bipolar plate 200, any number of arrangements of convex portions may be implemented on the bipolar plate 200.

A coating material 208 is disposed on at least a portion of the bipolar plate 200. For example, the coating material 208 can be disposed on the planar portion 202 and/or the concave portion 206, as shown in FIG. 2B. The coating material 208 is not disclosed on the portion of the bipolar plate 200 that contacts the electrode, e.g., the convex portion 204. The coating material 208 is an aerophobic material, in which an “aerophobic material,” as used herein represents a material that includes poor adhesion to gaseous compounds, e.g., oxygen and/or hydrogen. An acrophobic material may include a thickness of about 1 nm to about 100 μm. The acrophobic material can include a fluoropolymer material, e.g., polytetrafluoroethylene, or a silicone polymer, e.g., polydimethylsiloxane. Without being bound by theory, by applying polytetrafluoroethylene and/or polydimethylsiloxane to a portion of the bipolar plate that is not in contact with the electrode, e.g., the planar portion 402 and/or the concave portion 406, a reduction in adhesion between a gaseous bubble such as hydrogen and/or oxygen occurs, thereby directing the gaseous bubbles to the first or second channels, reducing overpotential and increasing overall energy efficiency of the electrolyzer cell 44.

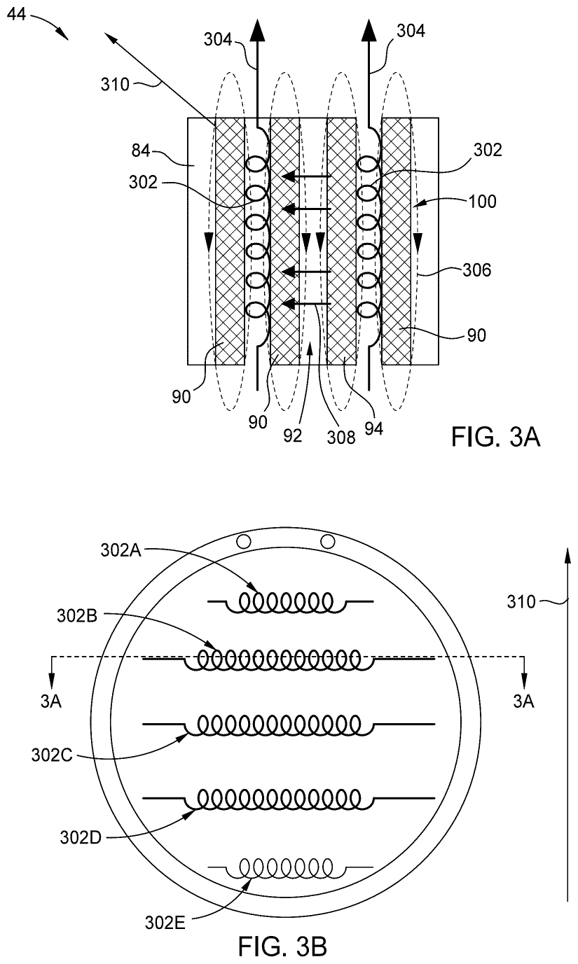

FIG. 3A shows a vertical cross-section of an electrolyzer cell 44 along line 3A-3A having an embedded electromagnetic conductive loop 302 in an electrode set, e.g., the first electrode set and/or the second electrode set. The electromagnetic conductive loop 302 can include a wire. The wire can include a conductive metal, e.g., copper, aluminum, gold, silver, nickel, or a combination thereof. The electromagnetic conductive loop 302 can be arranged in a coil, spiral and/or helical orientation to provide a coil shape of the wire. The electromagnetic conductive loop 302 is oriented horizontally within the electrode set. Optionally, the electromagnetic conductive loop 302 can be oriented vertically through the electrode set. Optionally, the electromagnetic conductive loop 302 can be proximal to the bipolar plate. Optionally, the electromagnetic conductive loop 302 can be proximal to the diaphragm 92. Optionally, the electromagnetic conductive loop 302 can be proximal to the first channel 88 and/or the second channel 96. Optionally, the electromagnetic conductive loop 302 can be embedded in the first channel 88 and/or the second channel 96.

A current flow 304 is passed through the electromagnetic conductive loop 302. The current flow 304 coupled with the spiral arrangement and/or coil arrangement can allow for an electromagnetic field 306 to be produced that is perpendicular to the velocity of the gaseous reaction produces, e.g. directed towards the first channel 88 and/or the second channel 96. The electromagnetic field 306 may proceed from a northern pole of the electromagnetic conductive loop 302, e.g., location where the current is flowing towards, to a southern pole, e.g., location where the current is flowing from. An electric field 308 is produced using the second bipolar plate 100 and the first bipolar plate 84. The electric field is perpendicular to the electromagnetic field generated from the electromagnetic conductive loop 302.

A Lorentz force 310 is produced that is perpendicular to both the direction of the electromagnetic field 306 produced using the electromagnetic conductive loop 302 and the direction of the electric field 308 produced using the second bipolar plate 100 and the first bipolar plate 84. While the Lorentz force 310 is shown along a 2D representation in FIG. 3A, the Lorentz Force 310 will be appreciated to extend upward towards the first channel 88 and/or the second channel 96 as shown in FIG. 3B. Without being bound by theory, a Lorentz force directed towards the first channel 88 and/or the second channel 96 produced using a electromagnetic field and an electric field can enhanced removal of reaction products, e.g., gaseous O₂ and/or H₂, from the bipolar plates and/or electrodes, thereby promoting more efficient electrochemical reactions.

Optionally the first electrode 90 and/or the second electrode 94 can include a plurality of electromagnetic conductive loops 302A, 302B, 302C, 302D, and/or 302E, as shown in FIG. 3B. While the plurality of electromagnetic conductive loops are shown as oriented horizontally, the plurality of electromagnetic conductive loops 302 can be independently oriented horizontally and/or vertically. For example, a first electromagnetic conductive loop 302A can be oriented horizontally, and the second electromagnetic conductive loop 302B can be oriented vertically or in any direction in a vertical stand electrode plane. For example, a first electromagnetic conductive loop 302A, a second electromagnetic conductive loop 302B, and a third electromagnetic conductive loop 302C can be disposed in a substantially horizontal direction along a vertical stand electrode plane, e.g., a plane in which the electrode and/or bipolar plate extends. The first electromagnetic conductive loop 302A, the second electromagnetic conductive loop 302B, and the third electromagnetic conductive loop 302C can be parallel to each other, and separated by a distance. The first electromagnetic conductive loop 302A, the second electromagnetic conductive loop 302B, and the third electromagnetic conductive loop 302C can be separated by about 1 mm to about 1000 mm.

Optionally, the electrolyzer can include a third electrode set and a fourth electrode set. The third electrode set includes a third bipolar plate electrically coupled to the power source and a third electrode disposed adjacent to the third bipolar plate and in electrical contact with the third bipolar plate. The third electrode set is separated from the fourth electrode set using a second diaphragm, in which the third electrode is disposed adjacent to a first side of the second diaphragm. The fourth electrode set includes a fourth bipolar plate and a fourth electrode, in which the fourth electrode is disposed adjacent to a second side of the second diaphragm, the second side opposite the first side. Where the electrolyzer includes a first electrode set, a second electrode set, a third electrode set, and a fourth electrode set, at least one electromagnetic conductive loop is disposed within the first electrode set, the second electrode set, the third electrode set, and the fourth electrode set. For example, a first electromagnetic conductive loop can be embedded within the first electrode set, while the second electrode set, the third electrode set, and the fourth electrode set do not include a electromagnetic conductive loop.

One of the electromagnetic conductive loops, of the plurality of electromagnetic conductive loops can be embedded adjacent to and/or proximal to the first channel 88 and/or the second channel 96. Without being bound by theory, by embedding one of the electromagnetic conductive loops adjacent to and/or proximal to the first channel 88 and/or the second channel 96, the gaseous reaction products, e.g., hydrogen and/or oxygen, may be directed towards the first channel 88 and/or the second channel 96, thereby improving device efficiency and reducing the pump power requirement for the water flowing into the electrolyzer cell 44.

The first bipolar plate 84 can abut the first electrode 90, which can abut the diaphragm 92, and the second bipolar plate 100 can abut the second electrode 94, which can abut the diaphragm 92, thereby reducing one or more gaps formed between the first bipolar plate 84, the first electrode 90, the diaphragm 92, the second electrode 94, and/or the second bipolar plate 100. Without being bound by theory, by reducing one or more gaps formed in the electrolyzer cell 44, the Lorentz force 310 can be focused in the electrolyzer cell 44, thereby improving the force exerted on the gaseous bubbles, and increasing gas expulsion and efficiency of the electrolysis process. Moreover, and without being bound by theory, improving the Lorentz force exerted on the gaseous bubbles can reduce and/or eliminate hydrogen permeation through the diaphragm, thereby increasing safety and improving gas purity.

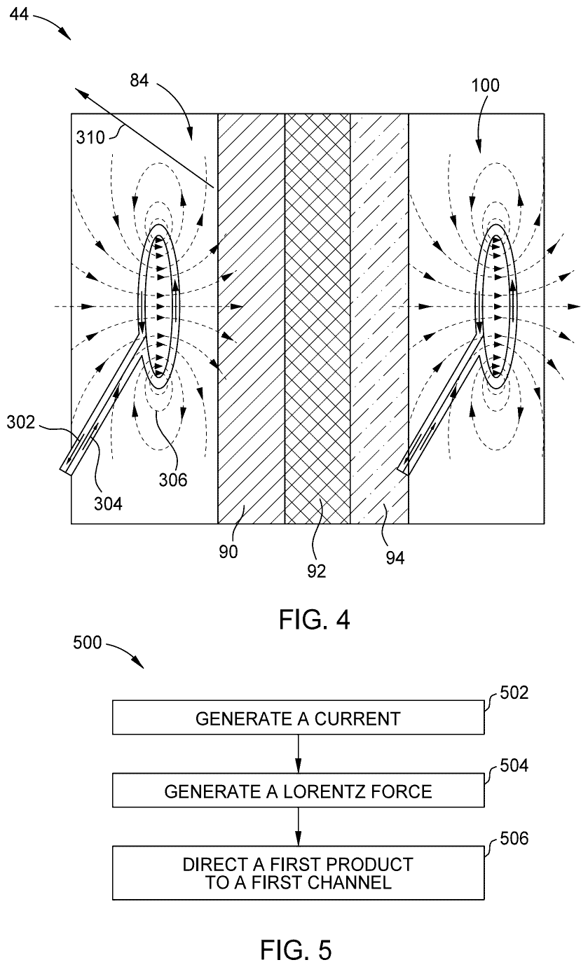

FIG. 4 is a schematic view of an electrolyzer cell 44 having an embedded electromagnetic conductive loop 302 in the bipolar plate. The electromagnetic conductive loop 302 can be oriented as a spiral wire, loop, and/or circle and embedded in the bipolar plates, e.g., first bipolar plate 84 and/or second bipolar plate 100. The spiral wire, loop, and/or circle may include a diameter of about 100 mm to about 2000 mm A current flow 304, e.g., a DC current, may be passed through the spiral wire, loop, and/or circle to produce electromagnetic field 306. The electromagnetic field 306 may be produced such that one end of the electromagnetic conductive loop 302, e.g., spiral wire and/or coiled wire, is a north pole and the other end is the south pole, as shown in FIG. 4. The current flow 304 may be increased and/or decreased to increase or decreased the strength of the electromagnetic field 306 such that a perpendicular Lorentz Force 310 is produced within the electrolyzer cell 44. While only one electromagnetic conductive loop 302 is shown for each of the first bipolar plate 84 and the second bipolar plate 100, any number of electromagnetic conductive loops may be embedded within the first bipolar plate 84 and/or the second bipolar plate 100 such that an electromagnetic field 306 is produced. For example, a plurality of electromagnetic conductive loops may be embedded within the first bipolar plate 84, the second bipolar plate 100, the first electrode 90, the second electrode 94, the first channel 88, and/or the second channel 96. Without being bound by theory, by embedding the electromagnetic conductive loop 302 in one or more of the bipolar plates an increase in efficiency of electrolysis may occur, while maintaining reduced manufacturing costs.

The first bipolar plate 84 can abut the first electrode 90, which can abut the diaphragm 92, and the second bipolar plate 100 can abut the second electrode 94, which can abut the diaphragm 92, thereby reducing one or more gaps formed between the first bipolar plate 84, the first electrode 90, the diaphragm 92, the second electrode 94, and/or the second bipolar plate 100. The first bipolar plate 84 can include a first spiral wire, loop, and/or circle embedded in the first bipolar plate 84, and the second bipolar plate 100 can include a second spiral wire, loop, and/or circle embedded in the second bipolar plate 100. Without being bound by theory, by reducing one or more gaps formed in the electrolyzer cell 44, the Lorentz force 310 can be focused in the electrolyzer cell 44, thereby improving the force exerted on the gaseous bubbles, and increasing gas expulsion and efficiency of the electrolysis process. Moreover, and without being bound by theory, improving the Lorentz force exerted on the gaseous bubbles can reduce and/or eliminate hydrogen permeation through the diaphragm, thereby increasing safety and improving gas purity.

FIG. 5 shows a flow diagram of a method 500 for electrolyzing water. The method includes, at step 502, generating a current, e.g., a DC current, between a first electrode set and a second electrode set that are separated by a diaphragm 92. Water is circulated within one of the first electrode set or the second electrode set. The first electrode set includes a first bipolar plate 84 electrically coupled to a power source 108. A first electrode 90 is disposed adjacent to the first bipolar plate 84 and to a first side of the diaphragm 92, and in electrical contact with the first bipolar plate 84. The second electrode set includes a second bipolar plate 100 and a second electrode 94. The second electrode is disposed adjacent to a second side of the diaphragm. The second side of the diaphragm is opposite the first side of the diaphragm. The second electrode 94 is in electrical contact with the second bipolar plate 100. The current, in the presence of water, produces an electrolysis reaction converting H₂O to H₂ and O₂.

A power source 108 provides a positive charge to the first bipolar plate 84, and a negative charge to the second bipolar plate 100, thereby creating a voltage difference across the first electrode 90 and the second electrode 94, which are each electrically coupled to the first bipolar plate 84 and the second bipolar plate 100, respectively. The charge difference creates the current, e.g., electric field 308, that is directed towards the first bipolar plate 84.

At operation 504, a first Lorentz force 310 is generated such that the Lorentz force 310 is oriented substantially towards a first channel 88. The Lorentz force 310 is generated using a first electromagnetic conductive loop 302 disposed within the first electrode set. The first electromagnetic conductive loop 302 can be embedded within the first bipolar plate 84, the first electrode 90, the second electrode 94, and/or the second bipolar plate 100.

A current flow 304 is passed through the electromagnetic conductive loop 302 to produce an electromagnetic field 306 that is perpendicular to the electric field 308 produced by the first bipolar plate 84 and second bipolar plate 100. The Lorentz force 310 is generated based on the electric field 308 and the electromagnetic field 306, in which the Lorentz force 310 is parallel to the first bipolar plate 84 and the second bipolar plate 100.

At operation 506, a first product of an electrolysis reaction, e.g., O₂, is directed to the first channel 86 fluidly coupled to the first electrode 90 using the diaphragm 92 and the first Lorentz force 310. For example, the OH⁻ may pass through the diaphragm 92, in which the OH⁻ may prevented from diffusing back through the diaphragm 92 due to the diaphragm 92 and the current, e.g., electric field 308. The OH may be oxidized at the first electrode 90 to form O₂ and be directed by the first Lorentz force 310, e.g., force parallel to the first bipolar plate 84 and/or the first electrode 90, to the first channel 88.

A second product of an electrolysis reaction, e.g., H₂, is directed to the second channel 96 fluidly coupled to the second electrode 94 using the diaphragm 92 and the first Lorentz force 310. The water may reduced at the second electrode 94 to form H₂ and be directed by the first Lorentz force 310, e.g., force parallel to the second bipolar plate 100 and/or the second electrode 94, to the second channel 96.

A second Lorentz force may be generated in a second electrode set. The second electrode set can include a second electromagnetic conductive loop, which can generate a second electromagnetic field that is perpendicular to the electric field 308 when directing a second current flow through the second electromagnetic conductive loop. The second electromagnetic field can allow for a second Lorentz force to be produced. The second Lorentz force and the diaphragm 92 may direct the second product of the electrolysis reaction, e.g., H₂, to the second channel 96.

Overall, the present disclosure relates to systems and methods of water electrolysis. The present disclosure includes a coating material disposed on a bipolar plate, e.g., a concave or planar portion of the bipolar plate, to prevent bubble adhesion to the bipolar plate walls. The coating material facilitates movement of the bubbles, e.g., gas bubbles of hydrogen and/or oxygen, towards the manifold to help improve overall energy efficiency and reduce over potential. Additionally, the present disclosure includes an electromagnetic conductive loop embedded within the electrode and/or bipolar plate to generate a Lorentz force parallel to the bipolar plate, thereby directing gas bubbles to a first channel and/or second channel of a manifold. The electromagnetic conductive loops can be mounted directly to the bipolar plate and/or the electrode, thereby providing a Lorentz force to direct bubbles e.g., gas bubbles of hydrogen and/or oxygen, towards the manifold to help improve overall energy efficiency and reduce over potential. The present disclosure can provide a large-scale water electrolysis process capable of creating a Lorentz force using the electromagnetic field thereby avoiding large-scale magnets that may pose health hazards and/or be costly.

Numerical ranges used herein include the numbers recited in the range. For example, the numerical range “from 1 wt % to 10 wt %” includes 1 wt % and 10 wt % within the recited range.

For the sake of brevity, only some ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

### Embodiments

Implementation examples are described in the following numbered clauses:
E1. A system for electrolyzing water, the system comprising a first electrode set comprising a first bipolar plate electrically coupled to a power source, and a first electrode disposed adjacent to the first bipolar plate and in electrical contact with the first bipolar plate, a diaphragm, wherein the first electrode is disposed adjacent to a first side of the diaphragm; a second electrode set comprising: a second bipolar plate and a second electrode, wherein the second electrode is disposed adjacent to a second side of the diaphragm, the second side opposite the first side; and at least a first electromagnetic conductive loop embedded within the first electrode set, wherein the first electromagnetic conductive loop is oriented horizontally along a vertical stand electrode plane.
E2. The system of embodiment E1, wherein the first electromagnetic conductive loop is embedded in the first bipolar plate.
E3. The system of embodiment E2, wherein the first electromagnetic conductive loop is proximal to a first channel fluidly coupled to the first electrode set.
E4. The system of embodiment E3, wherein the first electromagnetic conductive loop is embedded within the first channel of the first electrode set.
E5. The system of any one of embodiments E1-E4, wherein the first electromagnetic conductive loop is embedded in the first electrode.
E6. The system of any one of embodiments E1-E5, further comprising a second electromagnetic conductive loop embedded within the second electrode set.
E7. The system of embodiment E6, wherein the second electromagnetic conductive loop is embedded in the second bipolar plate.
E8. The system of embodiment E7, wherein the second electromagnetic conductive loop is proximal to a second channel fluidly coupled to the second electrode set.
E9. The system of embodiment E8, wherein the second electromagnetic conductive loop is embedded within the second channel of the second electrode set.
E10. The system of embodiment E6, wherein the second electromagnetic conductive loop is embedded in the second electrode.
E11. The system of any one of embodiments E1-E10, wherein the first electromagnetic conductive loop comprises a coil.
E12. The system of any one of embodiments E1-E11, wherein the first electrode set comprises a third electromagnetic conductive loop, wherein the third electromagnetic conductive loop is disposed in a substantially horizontal direction and parallel to the first electromagnetic conductive loop.
E13. The system of any one of embodiments E1-E12, wherein the first bipolar plate comprises a first coating material disposed over a first portion of the first bipolar plate.
E14. The system of embodiment E13, wherein the second bipolar plate comprises a second coating material disposed over a portion of the second bipolar plate.
E15. The system of embodiment E14, wherein the first coating material and the second coating material independently comprises an acrophobic material.
E16. The system of embodiment E15, wherein the acrophobic material comprises a fluoropolymer or a silicone polymer.
E17. The system of embodiment E13, wherein the first bipolar plate comprises a first uncoated portion in contact with the first electrode, and the second bipolar plate comprises a second uncoated portion in contact with the second electrode.
E18. The system of any one of embodiments E1-E17, further comprises a third electrode set and a fourth electrode set, wherein: the third electrode set comprises: a third bipolar plate electrically coupled to the power source, and a third electrode disposed adjacent to the third bipolar plate and in electrical contact with the third bipolar plate, a second diaphragm, wherein the third electrode is disposed adjacent to a first side of the second diaphragm; and the fourth electrode set comprises a fourth bipolar plate and a fourth electrode, wherein the fourth electrode is disposed adjacent to a second side of the second diaphragm, the second side opposite the first side;
E19. A method for electrolyzing water, the method comprising: generating a current between a first electrode set and a second electrode set separated by a diaphragm, and circulating water within one of the first electrode set or the second electrode set, wherein the first electrode set comprises a first bipolar plate electrically coupled to a power source, and a first electrode disposed adjacent to the first bipolar plate and to a first side of the diaphragm and in electrical contact with the first bipolar plate, wherein the second electrode set comprises a second bipolar plate and a second electrode, the second electrode is disposed adjacent to a second side of the diaphragm, the second side opposite the first side, and in electrical contact with the second bipolar plate, and wherein the current, in the presence of water, produces an electrolysis reaction generating a first Lorentz force oriented substantially towards a first channel, in the first electrode set using a first electromagnetic conductive loop; and directing a first product of the electrolysis reaction to a first channel fluidly coupled to the first electrode set using a diaphragm and the first Lorentz force.
E20. The method of embodiment E19, wherein generating the first Lorentz force in the first electrode set further comprises introducing a first current through the first electromagnetic conductive loop.
E21. The method of embodiments E19 or E20, further comprising directing a second product of the electrolysis reaction to a second channel fluidly coupled to a second electrode set using the membrane and the first Lorentz force.
E22. The method of any one of embodiments E19-E21, further comprising: generating a second Lorentz force in the second electrode set, wherein the second electrode set further comprises the second electromagnetic conductive loop; and directing the second product of the electrolysis reaction to the second channel fluidly coupled to the second electrode set using the diaphragm and the second Lorentz force.
E23. The method of embodiment E22, wherein generating the second Lorentz force in the second electrode set further comprises introducing a second current through the second electromagnetic conductive loop. While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A system for electrolyzing water, the system comprising
a first electrode set comprising:
a first bipolar plate electrically coupled to a power source, and
a first electrode disposed adjacent to the first bipolar plate and in electrical contact with the first bipolar plate,
a diaphragm, wherein the first electrode is disposed adjacent to a first side of the diaphragm;
a second electrode set comprising:
a second bipolar plate and a second electrode, wherein the second electrode is disposed adjacent to a second side of the diaphragm, the second side opposite the first side; and
at least a first electromagnetic conductive loop embedded within the first electrode set, wherein the first electromagnetic conductive loop is oriented horizontally along a vertical stand electrode plane.

2. The system of claim 1, wherein the first electromagnetic conductive loop is embedded in the first bipolar plate.

3. The system of claim 2, wherein the first electromagnetic conductive loop is proximal to a first channel fluidly coupled to the first electrode set.

4. The system of claim 3, wherein the first electromagnetic conductive loop is embedded within the first channel of the first electrode set.

5. The system of claim 1, wherein the first electromagnetic conductive loop is embedded in the first electrode.

6. The system of claim 1, further comprising a second electromagnetic conductive loop embedded within the second electrode set.

7. The system of claim 6, wherein the second electromagnetic conductive loop is embedded in the second bipolar plate, and the second electromagnetic conductive loop is embedded within a second channel fluidly coupled to the second electrode set.

8. The system of claim 6, wherein the second electromagnetic conductive loop is embedded in the second electrode.

9. The system of claim 1, wherein the first electromagnetic conductive loop comprises a coil.

10. The system of claim 1, wherein the first electrode set comprises a third electromagnetic conductive loop, wherein the third electromagnetic conductive loop is disposed in a substantially horizontal direction and parallel to the first electromagnetic conductive loop.

11. The system of claim 1, wherein the first bipolar plate comprises a first coating material disposed over a first portion of the first bipolar plate.

12. The system of claim 11, wherein the second bipolar plate comprises a second coating material disposed over a portion of the second bipolar plate, wherein the first coating material and the second coating material independently comprises an aerophobic material, and the aerophobic material comprises a fluoropolymer or a silicone polymer.

13. The system of claim 11, wherein the first bipolar plate comprises a first uncoated portion in contact with the first electrode, and the second bipolar plate comprises a second uncoated portion in contact with the second electrode.

14. The system of claim 1, further comprises a third electrode set and a fourth electrode set, wherein:
the third electrode set comprises:
a third bipolar plate electrically coupled to the power source, and
a third electrode disposed adjacent to the third bipolar plate and in electrical contact with the third bipolar plate,
a second diaphragm, wherein the third electrode is disposed adjacent to a first side of the second diaphragm; and
the fourth electrode set comprises:
a fourth bipolar plate and a fourth electrode, wherein the fourth electrode is disposed adjacent to a second side of the second diaphragm, the second side opposite the first side.

15. A method for electrolyzing water, the method comprising:
generating a current between a first electrode set and a second electrode set separated by a diaphragm, and circulating water within one of the first electrode set or the second electrode set,
wherein the first electrode set comprises a first bipolar plate electrically coupled to a power source, and a first electrode disposed adjacent to the first bipolar plate and to a first side of the diaphragm and in electrical contact with the first bipolar plate,
wherein the second electrode set comprises a second bipolar plate and a second electrode, the second electrode is disposed adjacent to a second side of the diaphragm, the second side opposite the first side, and in electrical contact with the second bipolar plate, and
wherein the current, in the presence of water, produces an electrolysis reaction
generating a first Lorentz force oriented substantially towards a first channel, in the first electrode set using a first electromagnetic conductive loop; and
directing a first product of the electrolysis reaction to a first channel fluidly coupled to the first electrode set using a diaphragm and the first Lorentz force.

16. The method of claim 15, wherein generating the first Lorentz force in the first electrode set further comprises introducing a first current through the first electromagnetic conductive loop.

17. The method of claim 15, further comprising directing a second product of the electrolysis reaction to a second channel fluidly coupled to a second electrode set using the diaphragm and the first Lorentz force.

18. The method of claim 15, further comprising:
generating a second Lorentz force in the second electrode set, wherein the second electrode set further comprises a second electromagnetic conductive loop; and
directing the second product of the electrolysis reaction to the second channel fluidly coupled to the second electrode set using the diaphragm and the second Lorentz force.

19. The method of claim 18, wherein generating the second Lorentz force in the second electrode set further comprises introducing a second current through the second electromagnetic conductive loop.

20. The method of claim 18, wherein the second Lorentz force is oriented substantially towards the channel.
